(19) United States
(12) Patent Application Publication
(10) Pub. No.: US 2024/0210939 A1
(43) Pub. Date: Jun. 27, 2024

(54) CAMERA IMAGE COMPRESSION FOR AUTONOMOUS DRIVING VEHICLES

(71) Applicant: Apollo Autonomous Driving USA LLC, Sunnyvale, CA (US)

(72) Inventors: Guoli SHU, Sunnyvale, CA (US); Manjiang ZHANG, Sunnyvale, CA (US)

(21) Appl. No.: 18/069,676

(22) Filed: Dec. 21, 2022

(51) Int. Cl. G05D 1/00; B60W 60/00; G06V 20/56

(52) U.S. Cl. CPC G05D 1/0038; B60W 60/001; G06V 20/56; B60W 2420/42

(57) ABSTRACT

A cost-latency balanced method of processing camera image data in an autonomous driving vehicle (ADV) is described. The ADV includes a main compute unit coupled to an FPGA unit and a graphical processing unit (GPU). The method includes receiving, by the main compute unit, a full raw image data and a partial compressed image data from the FPGA unit, the full raw image being raw image data captured by all cameras mounted on the ADV, and the partial compressed image data being compressed from a partial raw image data captured by a subset of the cameras mounted on the ADV. The method further includes transmitting the partial compressed image data to a remote driving operation center; and consuming the full raw image data for environment perception, and the full raw image data is also compressed into a full compressed image data by the GPU for use in offline processing.

### TECHNICAL FIELD

Embodiments of the present disclosure relate generally to autonomous driving vehicles. More particularly, embodiments of the disclosure relate to image data compression in an autonomous driving vehicle.

### BACKGROUND

An autonomous driving vehicle (ADV) is a vehicle that operates in an autonomous mode (e.g., driverless), and that can relieve occupants, especially the driver, from some driving-related responsibilities.

Camera image data captured by an ADV while the ADV is in motion can be used for many purposes. For example, the captured camera image data can be used by the ADV to perceive its surrounding environment. As another example, the captured camera image data can be stored in a cloud environment for machine learning model training. Yet as another example, the captured camera image data can be used for remote driving.

Each use case has a different requirement for image data. For one use case, the image data needs to be compressed and tele-transmitted to a remote location. For another use, raw image data would be sufficient. Even for the use case where image data needs to be compressed, different hardware processors can be used for image data compression, and these processors differ in terms of cost, compression latency, and configuration flexibility. Thus, it would be desirable for an ADV to have a computing system that can process camera image data in a manner that meets the requirements for camera image data in all use cases without significantly increasing the cost of the ADV.

### BRIEF DESCRIPTION OF THE DRAWINGS

Embodiments of the disclosure are illustrated by way of example and not limitation in the figures of the accompanying drawings in which like references indicate similar elements.

FIG. 1 illustrates a computing system for image data processing in an ADV according to an embodiment of the invention.

FIG. 2 illustrates a data flow for processing image data for remote driving according to an embodiment of the invention.

FIG. 3 illustrates a data flow for processing image data for offline storage according to an embodiment of the invention.

FIG. 4 illustrates a process of processing image data captured by camera in an ADV according on embodiment of the invention.

FIG. 5 is a block diagram illustrating an autonomous driving vehicle according to one embodiment.

FIG. 6 is a block diagram illustrating an example of an autonomous driving vehicle according to one embodiment.

FIG. 7 is a block diagram illustrating an example of an autonomous driving system used with an autonomous driving vehicle according to one embodiment.

FIGS. 8A and 8B are block diagrams illustrating an example of a sensor unit according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

As described above, image data captured by video cameras mounted on an ADV needs to be compressed in order to be tele-transmitted to a remote site. Various types of processors can be used to compress image data, and each type of processors has its own advantages and disadvantages in image compression in terms of a number of metrics, including cost, latency, and configuration flexibility.

For example, among the three types of processors—a central processing unit (CPU), a graphics processing unit (GPU), and a field programmable gate array (FPGA)—the CPU, compared with the other two types of processors, has the lowest cost and the highest latency, but the highest configuration flexibility, whereas the FPGA processor has the highest cost, but the lowest latency and the lowest configuration flexibility. The GPU, however, is somewhere in between in terms of all the above-mentioned metrics.

According to various embodiments, the disclosure describes a system and a method for processing camera image data captured by cameras mounted on the ADV.

In an embodiment, a cost-latency balanced method of processing camera image data in ADV is described. The method is performed when the ADV is in motion. The ADV includes a main compute unit coupled to an FPGA unit and a GPU. The method includes receiving, by the main compute unit, a full raw image data and a partial compressed image data from the FPGA unit, the full raw image data being raw image data captured by all cameras mounted on the ADV, and the partial compressed image data being compressed from a partial raw image data captured by a subset of the cameras mounted on the ADV. The method further includes transmitting the partial compressed image data to a remote driving operation center; and consuming the full raw image data for environment perception, wherein the full raw image data is also compressed into a full compressed image data by the GPU for use in offline processing.

In an embodiment, when compressing the full raw image data into the full compressed image data, the main compute unit can call software application program interfaces (APIs) of the GPU to perform the compression, or sending the full raw image data to the GPU for compression.

In an embodiment, the FPGA unit includes a logic block for specifying the subset of the plurality of cameras. The FPGA unit includes an image data compression block which is programmed to compress the partial raw image data into the partial compressed image data. The partial compressed image data is transmitted from the FPGA unit to the main compute unit as user datagram protocol (UDP) packets.

In an embodiment, the main compute unit is coupled to the FPGA unit via an Ethernet interface and a first peripheral component interconnect express (PCIe) interface. The Ethernet interface is used to transmit the partial compressed image data from the FPGA unit to the main compute unit.

The above summary does not include an exhaustive list of all aspects of the present invention. It is contemplated that the invention includes all devices, computer media, and methods that can be practiced from all suitable combinations of the various aspects summarized above, and also those disclosed in the Detailed Description below.

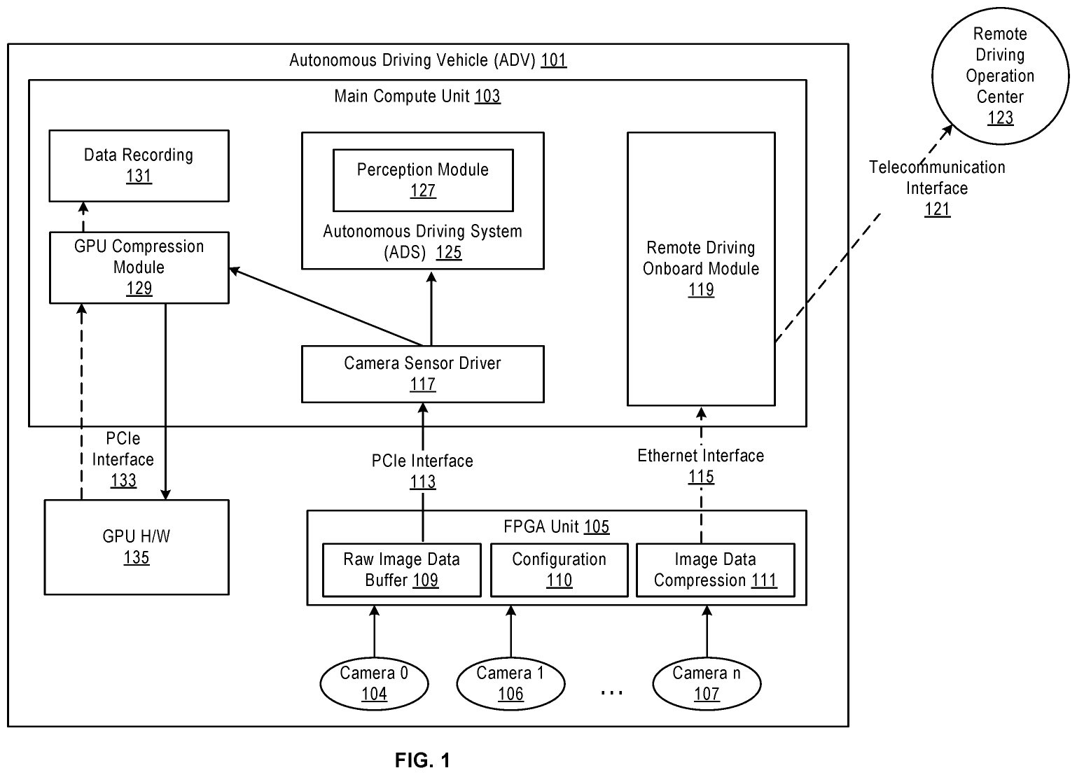

FIG. 1 illustrates a computing system for image data processing in an ADV according to an embodiment of the invention. As shown in FIG. 1, an ADV 101 can include a main compute unit 103 that is coupled to a FPGA unit 105, and a GPU 135. The main compute unit 103 can comprise one or more CPUs, and/or one or more electronic control units (ECU). The main compute unit 103 can run the vehicle operating system (Vos) and multiple services and applications for operating the ADV 101. Each of the GPU 135 and the FPGA unit 105 can be a system-on-a-chip (SOC).

In an embodiment, operating the ADV 101 needs camera data for environment perception. For example, the ADV 101 needs to perceive the surrounding environment before it can generate planned trajectories and avoid obstacle objects on the road. The ADV 101 may also need image data for remotely controlling the ADV 101 in an emergency situation, e.g., when one or more sensors fails, which make it impossible for the default autonomous driving system (ADS) of the ADV 101 to safely operate the vehicle. The ADV 101 may also needs to store the image data for offline processing to serve various purposes, e.g., for training machine learning models. Thus, the cameras on the ADV 101 may be configured to capture the surrounding environment periodically, e.g., at each planned cycle, or at any predetermined fixed intervals.

Each of the above-mentioned scenarios may have a different requirements for the camera image data. For example, for the purpose of environment perception, raw image data from all the cameras may be needed because a full and detailed picture of the surrounding environment can enable the ADV to plan more accurate trajectories and drive more safely. In this disclosure, the raw camera image data captured by all the cameras on the ADV at each predetermined fixed interval is refer to as “full raw image data”, and the compressed image data from the full raw image data is referred to as “full compressed image data.”

For the purpose of remote driving, a remote driver does not need to see the surrounding environment in such details as the ADV for automatic driving, because the remote driver typically is well trained, and can remotely operate the vehicle as long as the drive can see the environment in sufficient details. Thus, raw image data from a subset camera of all the cameras mounted on the ADV 101 should be sufficient to meet the remote driving needs of the remote driver. However, the raw image data from the subset of cameras needs to be transmitted in a manner that is as close to real-time as possible. Thus, the raw image data from the subset of cameras needs to be compressed with low compression latency, and the compressed image data can then be tele-transmitted to a remote driving operation center with low transmission latency. In this disclosure, the raw image data captured by the subset of camera at each fixed interval is referred to as “partial raw image data”, and the compressed image data from the partial raw image data is referred to as “partial compressed image data.”

For the purpose of image data storage in a cloud environment, all the raw image data (i.e., the full raw image data) captured by the cameras may need to be stored in the cloud. Thus, the full raw image data may be compressed for faster transmission to the cloud. However, the compression latency and transmission latency may not be as critical as they are for remote driving.

As used in this disclosure, cost refers to price, latency of compression refers to the amount of time it takes to compress raw data into compressed data, transmission latency refers to the amount of time it takes for data packets to travel across a network from a sender to a receiver. Further, as used in this disclosure, configuration flexibility refers to how easy it is to change the configuration parameters (e.g., compression ratio, compression format) for compression. A CPU can be easily configured because the configuration parameters can be stored in a file of a compression software application. For an FPGA processor, however, each time a configuration parameter is changed, the FPGA processor needs to be reboot. For a GPU processor, configuration parameters may rely on libraries provide by vendors, and thus can be limited in configuration flexibility.

In view of the foregoing description, the computing system in this embodiment uses a balanced approach to processing the camera image data such that the cost of the computing system can be controlled while the image data requirements for each scenario can still be met.

Referring back to FIG. 1, a cost/latency balanced solution for image data processing is described. From a high level, the FPGA unit 105 is used to compress the partial raw image data for remote driving, because remote driving needs the camera image data to be transmitted to a remote operation center 123 as fast as it can to show the surrounding environment of the ADV 101, since both the compression latency and the transmission latency impact the safety of the vehicle that is being remotely controlled. The FPGA unit 105 has a low compression latency due to a number of factors, including (1) that no raw image data needs to be moved between a system memory, and (2) that the compression operation is performed in hardware logic blocks—no host software is involved the compression. According to the balanced solution, the GPU 135 is used to compress the full raw image data for the purpose of data recording (i.e., cloud storage for offline processing), because neither compression latency nor transmission latency is as critical as they are for remote driving in this case. However, image quality of the compressed data is critical because the compressed image data will be decompressed later for offline usages, such as simulation testing, perception training and troubleshooting etc. In image compression, modem GPUs are efficient compared with CPUs, and are cost-effective compared with FPGA units.

As further shown in FIG. 1, raw image data captured by serial cameras 104, 106, and 107 can first be passed to the FPGA unit 105, which buffers the raw data in a buffer 109, and waits for a camera sensor driver component 117 to obtain the full raw image data via PCIe interface 113, and put it in a main memory of the main compute unit 103. Meanwhile, the FPGA unit 105 can use a compression logic block 111 to compress raw image data (i.e., partial raw image data) from a subset of the cameras 104-107 into a corresponding compression format, and send the partial compressed data via an Ethernet interface 115 as user datagram protocol (UDP) packets to a remote driving onboard module 119 on the main compute unit 103. The remote driving onboard module 119 can receive the UDP packets of the compressed data, and then pass them to the remote driving operation center 123 via a telecommunication interface 121.

In an embodiment, the FPGA unit 105 can further include a configuration logic block 110, which can specify parameter values for data compression for the partial raw data, as well the subset of cameras that is used for remote driving. Examples of the compression parameters include a compressed data format and compression ratio. The image compression 111 is a logic block that can be programmed to implement a variety of compression algorithms, either lossless or lossy. Examples of the compression algorithms that can be implemented by the compression logic block 111 include the Lempel-Ziv compression method, the Lempel-Ziv-Welch, and the Wavelet compression.

As further shown, after obtaining the full raw image data from the image data buffer 109, the camera sensor driver component 117 can pass the full raw image data to a GPU compression 129 module, which can call software APIs of the GPU 135 to have the GPU 135 perform the image compression and then send the compressed data (i.e., full compressed data) to a data recording module 131. The data recording module 131 can transmit the full compressed data to a cloud server for offline processing.

Alternatively, instead of the GPU 135 being called via software APIs to perform the image compression, the GPU compression module 129 can send the full raw image data to the GPU 135 via a PCIe interface 133. The GPU can send the compressed image data back via the PCIe interface 133 to the GPU compression module 129.

As further shown, at the same time that camera sensor driver 117 sends the full raw image data to the GPU compression module 129, the camera sensor driver 117 sends the full raw image data to the ADS 125 such that a perception module 127 therein can consume the raw image data for operating the vehicle. The perception module 127 and the ADS 125 will be described in detail later in the disclosure.

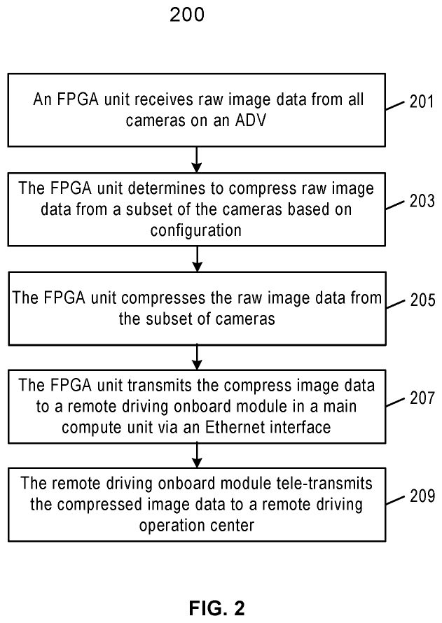

FIG. 2 illustrates a data flow 200 for processing image data for remote driving according to an embodiment of the invention. The data flow 200 occurs in an ADV while the ADV is driving on a road and the default ADS system of the ADV is functioning as expected. Each of the operations in the data flow 200 can be performed by hardware or software or a combination thereof.

As shown in the figure, in operation 201, an AFGA unit coupled to a main compute unit via an Ethernet interface can receive raw image data captured by all serial cameras mounted on the ADV. Each of the cameras can be connected to the FPGA unit directly and sends image data it captures to the FPGA unit.

In operation 203, the FPGA unit can determine a subset of camera that is configured to be used for remote driving. The determination can be based on a configuration logic block on the FPGA unit. The configuration logic block can specify one or more cameras that are used for remote driving based on, e.g., their positions on the ADV.

In operation 205, the FPGA unit can compress raw image data captured by the subset of cameras using one of a variety of compression algorithms. The compression algorithm can be implemented by a logic block on the FPGA unit, and either a lossless compression algorithm or a lossy compression algorithm can be used.

In operation 207, the FPGA unit transmits the compressed image data to a remote driving onboard module on the main compute unit via the Ethernet interface.

In operation 209, the remote driving onboard module can tele-transmit the compressed image data to a remote driving operation center for use by a remote driver to remotely operate the vehicle when needed, e.g., when one or more sensor failures or other failures cause the default ADS to malfunction.

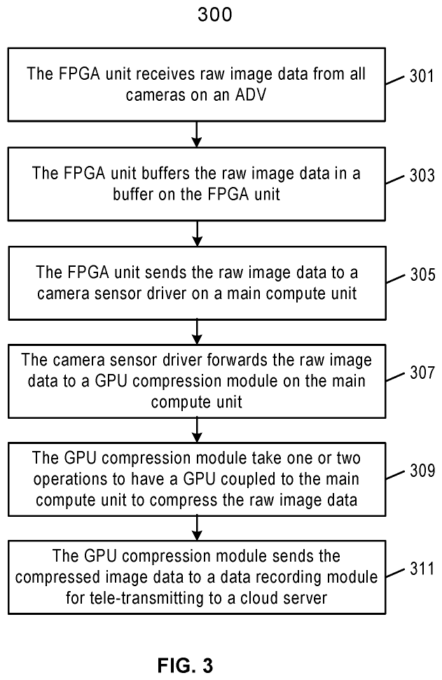

FIG. 3 illustrates a data flow 300 for processing image data for offline storage according to an embodiment of the invention. The data flow 300 similarly occurs in an ADV while the ADV is driving on a road and the default ADS system of the ADV is functioning as expected. Each of the operations in the data flow 300 can be performed by hardware or software or a combination thereof.

As shown in FIG. 3, in operation 301, an AFGA unit coupled to a main compute unit via an Ethernet interface can receive raw image data captured by all serial cameras mounted on the ADV. Each of the cameras can be connected to the FPGA unit directly and sends image data it captures to the FPGA unit.

In operation 303, the FPGA units buffers the raw image data in a buffer on the FPGA unit. The buffer can be a logic block on the FPGA, whose size can be specified by the configuration logic block mentioned above.

In operation 305, the FPGA unit sends the raw image data buffered therein to a camera sensor driver module on a main compute unit via a PCIe interface at the request of the driver module.

In operation 307, the camera sensor driver module forwards the raw image data to a GPU compression module on the main compute unit. Each of the camera sensor driver module and the GPU compression module is a software module running on the main compute unit.

In operation 309, the GPU compression unit can either call a set of software APIs provided by the GPU to compress the raw image data or send the raw image data to the GPU for compression.

In operation 311, the GPU compression module sends the compressed image data to a data recording module, which is another software module on the main compute unit. The recording module can tele-transmit the compressed image to a cloud server for offline processing for a variety of purposes, including machine learning model training.

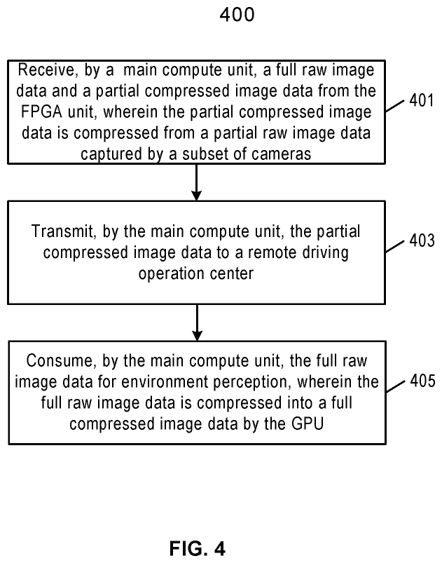

FIG. 4 illustrates a process 400 of processing image data captured by camera in an ADV according on embodiment of the invention. The process 400 can be performed by processing logic that comprises software, hardware, or a combination thereof. For example, the processing logic can include one or more of the main compute unit 103, the FPGA unit 105, and the GPU 135.

Referring to FIG. 4, in operation 401, the processing logic receives a full raw image data and a partial compressed image data from the FPGA unit. The full raw image data is raw image data captured by all cameras mounted on the ADV, and the partial compressed image data is compressed by the FPGA unit from a partial raw image data captured by a subset of the cameras mounted on the ADV. In operation 403, the processing logic transmits the partial compressed image data to a remote driving operation center. In operation 405, the processing logic consumes the full raw image data for environment perception, wherein the full raw image data is also compressed into a full compressed image data by a GPU and tele-transmitted to a cloud server for offline processing.

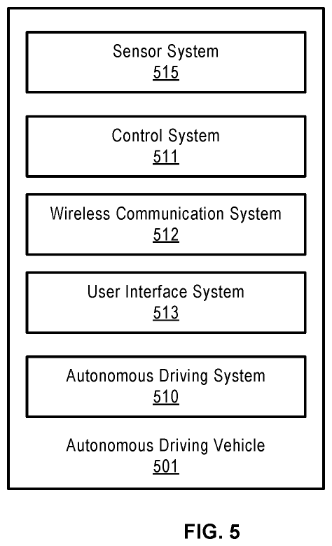

FIG. 5 is a block diagram illustrating an autonomous driving vehicle according to an embodiment of the invention. Referring to FIG. 5, autonomous driving vehicle 501 (the same ADV as ADV 101 in FIG. 1) may be communicatively coupled to one or more servers over a network, which may be any type of networks such as a local area network (LAN), a wide area network (WAN) such as the Internet, a cellular network, a satellite network, or a combination thereof, wired or wireless. The server(s) may be any kind of servers or a cluster of servers, such as Web or cloud servers, application servers, backend servers, or a combination thereof. A server may be a data analytics server, a content server, a traffic information server, a map and point of interest (MPOI) server, or a location server, etc.

An autonomous driving vehicle refers to a vehicle that can be configured to drive in an autonomous mode in which the vehicle navigates through an environment with little or no input from a driver. Such an autonomous driving vehicle can include a sensor system having one or more sensors that are configured to detect information about the environment in which the vehicle operates. The vehicle and its associated controller(s) use the detected information to navigate through the environment. Autonomous driving vehicle 501 can operate in a manual mode, a full autonomous mode, or a partial autonomous mode.

In one embodiment, autonomous driving vehicle 501 includes, but is not limited to, autonomous driving system (ADS) 510, vehicle control system 511, wireless communication system 512, user interface system 513, and sensor system 515. Autonomous driving vehicle 501 may further include certain common components included in ordinary vehicles, such as, an engine, wheels, steering wheel, transmission, etc., which may be controlled by vehicle control system 511 and/or ADS 510 using a variety of communication signals and/or commands, such as, for example, acceleration signals or commands, deceleration signals or commands, steering signals or commands, braking signals or commands, etc.

Components 510-515 may be communicatively coupled to each other via an interconnect, a bus, a network, or a combination thereof. For example, components 510-515 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

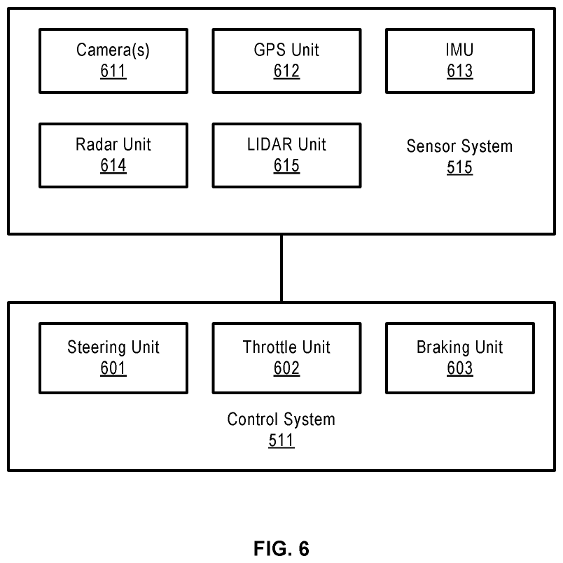

Referring now to FIG. 6, in one embodiment, sensor system 515 includes, but it is not limited to, one or more cameras 611, global positioning system (GPS) unit 612, inertial measurement unit (IMU) 613, radar unit 614, and a light detection and range (LIDAR) unit 615. GPS system 612 may include a transceiver operable to provide information regarding the position of the autonomous driving vehicle. IMU unit 613 may sense position and orientation changes of the autonomous driving vehicle based on inertial acceleration. Radar unit 614 may represent a system that utilizes radio signals to sense objects within the local environment of the autonomous driving vehicle. In some embodiments, in addition to sensing objects, radar unit 614 may additionally sense the speed and/or heading of the objects. LIDAR unit 615 may sense objects in the environment in which the autonomous driving vehicle is located using lasers. LIDAR unit 615 could include one or more laser sources, a laser scanner, and one or more detectors, among other system components. Cameras 611 may include one or more devices to capture images of the environment surrounding the autonomous driving vehicle. Cameras 611 may be still cameras and/or video cameras. A camera may be mechanically movable, for example, by mounting the camera on a rotating and/or tilting a platform.

Sensor system 515 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous driving vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 511 includes, but is not limited to, steering unit 601, throttle unit 602 (also referred to as an acceleration unit), and braking unit 603. Steering unit 601 is to adjust the direction or heading of the vehicle. Throttle unit 602 is to control the speed of the motor or engine that in turn controls the speed and acceleration of the vehicle. Braking unit 603 is to decelerate the vehicle by providing friction to slow the wheels or tires of the vehicle. Note that the components as shown in FIG. 6 may be implemented in hardware, software, or a combination thereof.

Referring back to FIG. 5, wireless communication system 512 is to allow communication between autonomous driving vehicle 501 and external systems, such as devices, sensors, other vehicles, etc. For example, wireless communication system 512 can wirelessly communicate with one or more devices directly or via a communication network. Wireless communication system 512 can use any cellular communication network or a wireless local area network (WLAN), e.g., using WiFi to communicate with another component or system. Wireless communication system 512 could communicate directly with a device (e.g., a mobile device of a passenger, a display device, a speaker within vehicle 501), for example, using an infrared link, Bluetooth, etc. User interface system 513 may be part of peripheral devices implemented within vehicle 501 including, for example, a keyboard, a touch screen display device, a microphone, and a speaker, etc.

Some or all of the functions of autonomous driving vehicle 501 may be controlled or managed by ADS 510, especially when operating in an autonomous driving mode. ADS 510 includes the necessary hardware (e.g., processor(s), memory, storage) and software (e.g., operating system, planning and routing programs) to receive information from sensor system 515, control system 511, wireless communication system 512, and/or user interface system 513, process the received information, plan a route or path from a starting point to a destination point, and then drive vehicle 501 based on the planning and control information. Alternatively, ADS 510 may be integrated with vehicle control system 511.

For example, a user as a passenger may specify a starting location and a destination of a trip, for example, via a user interface. ADS 510 obtains the trip related data. For example, ADS 510 may obtain location and route data from an MPOI server. The location server provides location services and the MPOI server provides map services and the POIs of certain locations. Alternatively, such location and MPOI information may be cached locally in a persistent storage device of ADS 510.

While autonomous driving vehicle 501 is moving along the route, ADS 510 may also obtain real-time traffic information from a traffic information system or server (TIS). Note that the servers may be operated by a third party entity. Alternatively, the functionalities of the servers may be integrated with ADS 510. Based on the real-time traffic information, MPOI information, and location information, as well as real-time local environment data detected or sensed by sensor system 515 (e.g., obstacles, objects, nearby vehicles), ADS 510 can plan an optimal route and drive vehicle 501, for example, via control system 511, according to the planned route to reach the specified destination safely and efficiently.

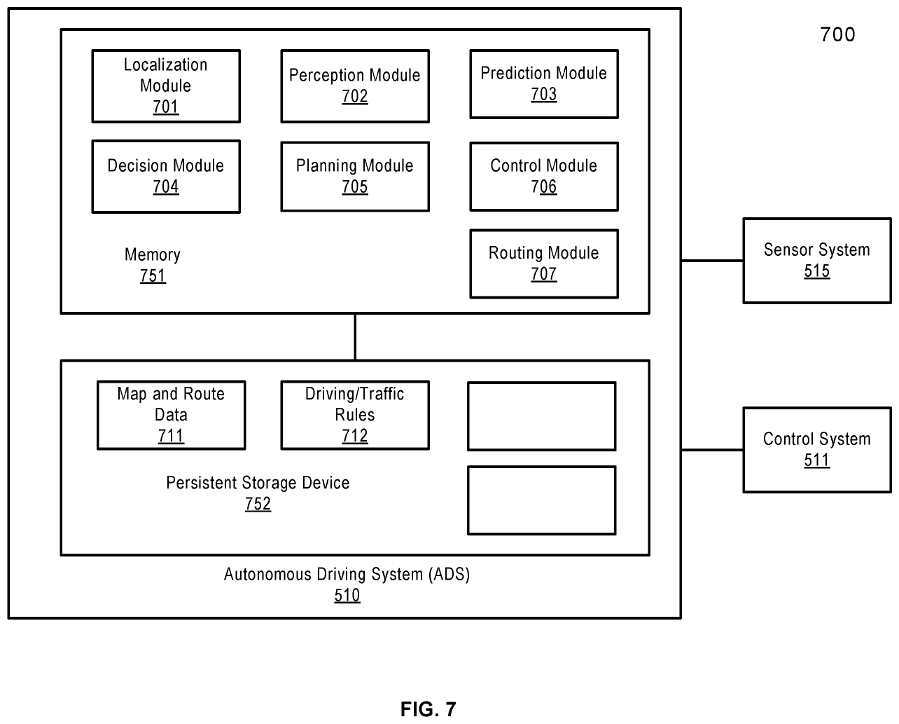

FIG. 7 is a block diagram illustrating an example of an autonomous driving system used with an autonomous driving vehicle according to one embodiment. System 700 may be implemented as a part of autonomous driving vehicle 501 of FIG. 5 including, but is not limited to, ADS 510 (the same as the ADS 125 in FIG. 1), control system 511, and sensor system 515. Referring to FIG. 7, ADS 510 includes, but is not limited to, localization module 701, perception module 702 (the same module as the perception module 127 in FIG. 1), prediction module 703, decision module 704, planning module 705, control module 706, and routing module 707.

Some or all of modules 701-707 may be implemented in software, hardware, or a combination thereof. For example, these modules may be installed in persistent storage device 752, loaded into memory 751, and executed by one or more processors (not shown). Note that some or all of these modules may be communicatively coupled to or integrated with some or all modules of vehicle control system 511 of FIG. 7. Some of modules 701-707 may be integrated together as an integrated module.

Localization module 701 determines a current location of autonomous driving vehicle 501 (e.g., leveraging GPS unit 712) and manages any data related to a trip or route of a user. Localization module 701 (also referred to as a map and route module) manages any data related to a trip or route of a user. A user may log in and specify a starting location and a destination of a trip, for example, via a user interface. Localization module 701 communicates with other components of autonomous driving vehicle 501, such as map and route data 711, to obtain the trip related data. For example, localization module 701 may obtain location and route data from a location server and a map and POI (MPOI) server. A location server provides location services and an MPOI server provides map services and the POIs of certain locations, which may be cached as part of map and route data 711. While autonomous driving vehicle 501 is moving along the route, localization module 701 may also obtain real-time traffic information from a traffic information system or server.

Based on the sensor data provided by sensor system 515 and localization information obtained by localization module 701, a perception of the surrounding environment is determined by perception module 702. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 702 may include a computer vision system or functionalities of a computer vision system to process and analyze images captured by one or more cameras in order to identify objects and/or features in the environment of autonomous driving vehicle. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 702 can also detect objects based on other sensors data provided by other sensors such as a radar and/or LIDAR.

For each of the objects, prediction module 703 predicts what the object will behave under the circumstances. The prediction is performed based on the perception data perceiving the driving environment at the point in time in view of a set of map/rout information 711 and traffic rules 712. For example, if the object is a vehicle at an opposing direction and the current driving environment includes an intersection, prediction module 703 will predict whether the vehicle will likely move straight forward or make a turn. If the perception data indicates that the intersection has no traffic light, prediction module 703 may predict that the vehicle may have to fully stop prior to enter the intersection. If the perception data indicates that the vehicle is currently at a left-turn only lane or a right-turn only lane, prediction module 703 may predict that the vehicle will more likely make a left turn or right turn respectively.

For each of the objects, decision module 704 makes a decision regarding how to handle the object. For example, for a particular object (e.g., another vehicle in a crossing route) as well as its metadata describing the object (e.g., a speed, direction, turning angle), decision module 704 decides how to encounter the object (e.g., overtake, yield, stop, pass). Decision module 704 may make such decisions according to a set of rules such as traffic rules or driving rules 712, which may be stored in persistent storage device 752.

Routing module 707 is configured to provide one or more routes or paths from a starting point to a destination point. For a given trip from a start location to a destination location, for example, received from a user, routing module 707 obtains route and map information 711 and determines all possible routes or paths from the starting location to reach the destination location. Routing module 707 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 704 and/or planning module 705. Decision module 704 and/or planning module 705 examine all of the possible routes to select and modify one of the most optimal routes in view of other data provided by other modules such as traffic conditions from localization module 701, driving environment perceived by perception module 702, and traffic condition predicted by prediction module 703. The actual path or route for controlling the ADV may be close to or different from the reference line provided by routing module 707 dependent upon the specific driving environment at the point in time.

Based on a decision for each of the objects perceived, planning module 705 plans a path or route for the autonomous driving vehicle, as well as driving parameters (e.g., distance, speed, and/or turning angle), using a reference line provided by routing module 707 as a basis. That is, for a given object, decision module 704 decides what to do with the object, while planning module 705 determines how to do it. For example, for a given object, decision module 704 may decide to pass the object, while planning module 705 may determine whether to pass on the left side or right side of the object. Planning and control data is generated by planning module 705 including information describing how vehicle 501 would move in a next moving cycle (e.g., next route/path segment). For example, the planning and control data may instruct vehicle 501 to move 10 meters at a speed of 30 mile per hour (mph), then change to a right lane at the speed of 25 mph.

Based on the planning and control data, control module 706 controls and drives the autonomous driving vehicle, by sending proper commands or signals to vehicle control system 511, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 705 plans a next route segment or path segment, for example, including a target position and the time required for the ADV to reach the target position. Alternatively, planning module 705 may further specify the specific speed, direction, and/or steering angle, etc. In one embodiment, planning module 705 plans a route segment or path segment for the next predetermined period of time such as 5 seconds. For each planning cycle, planning module 705 plans a target position for the current cycle (e.g., next 5 seconds) based on a target position planned in a previous cycle. Control module 706 then generates one or more control commands (e.g., throttle, brake, steering control commands) based on the planning and control data of the current cycle.

Note that decision module 704 and planning module 705 may be integrated as an integrated module. Decision module 704/planning module 705 may include a navigation system or functionalities of a navigation system to determine a driving path for the autonomous driving vehicle. For example, the navigation system may determine a series of speeds and directional headings to affect movement of the autonomous driving vehicle along a path that substantially avoids perceived obstacles while generally advancing the autonomous driving vehicle along a roadway-based path leading to an ultimate destination. The destination may be set according to user inputs via user interface system 513. The navigation system may update the driving path dynamically while the autonomous driving vehicle is in operation. The navigation system can incorporate data from a GPS system and one or more maps so as to determine the driving path for the autonomous driving vehicle.

According to one embodiment, a system architecture of an autonomous driving system as described above includes, but it is not limited to, an application layer, a planning and control (PNC) layer, a perception layer, a device driver layer, a firmware layer, and a hardware layer. The application layer may include user interface or configuration application that interacts with users or passengers of an autonomous driving vehicle, such as, for example, functionalities associated with user interface system 513. The PNC layer may include functionalities of at least planning module 705 and control module 706. The perception layer may include functionalities of at least perception module 702. In one embodiment, there is an additional layer including the functionalities of prediction module 703 and/or decision module 704. Alternatively, such functionalities may be included in the PNC layer and/or the perception layer. The firmware layer may represent at least the functionality of sensor system 515, which may be implemented in a form of a field programmable gate array (FPGA). The hardware layer may represent the hardware of the autonomous driving vehicle such as control system 511. The application layer, PNC layer, and perception layer can communicate with the firmware layer and hardware layer via the device driver layer.

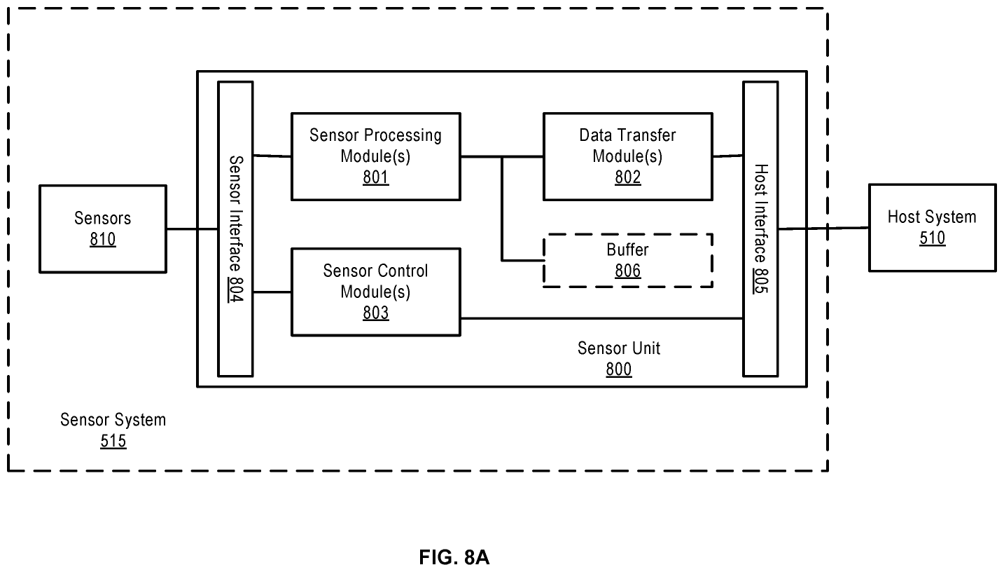

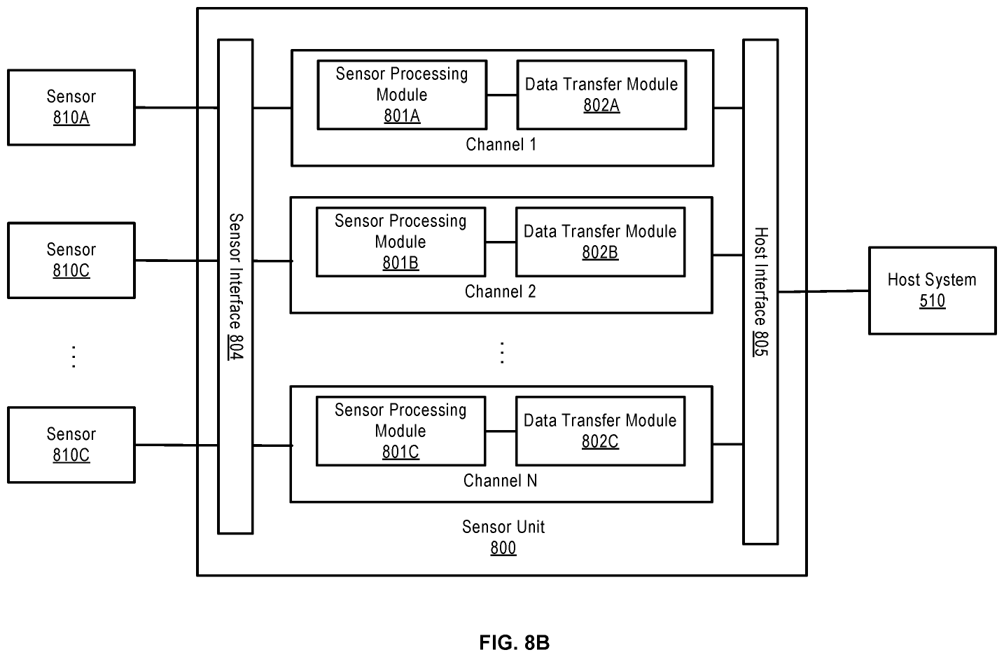

FIG. 8A is a block diagram illustrating an example of a sensor system according to one embodiment of the invention. Referring to FIG. 8A, sensor system 515 includes a number of sensors 810 and a sensor unit 800 coupled to host system 510. Host system 510 represents a planning and control system as described above, which may include at least some of the modules as shown in FIG. 7. Sensor unit 800 may be implemented in a form of an FPGA device or an ASIC (application specific integrated circuit) device. In one embodiment, sensor unit 800 includes, amongst others, one or more sensor data processing modules 801 (also simply referred to as sensor processing modules), data transfer modules 802, and sensor control modules or logic 803. Modules 801-803 can communicate with sensors 810 via a sensor interface 804 and communicate with host system 510 via host interface 805. Optionally, an internal or external buffer 806 may be utilized for buffering the data for processing.

In one embodiment, for the receiving path or upstream direction, sensor processing module 801 is configured to receive sensor data from a sensor via sensor interface 804 and process the sensor data (e.g., format conversion, error checking), which may be temporarily stored in buffer 806. Data transfer module 802 is configured to transfer the processed data to host system 510 using a communication protocol compatible with host interface 805. Similarly, for the transmitting path or downstream direction, data transfer module 802 is configured to receive data or commands from host system 510. The data is then processed by sensor processing module 801 to a format that is compatible with the corresponding sensor. The processed data is then transmitted to the sensor.

In one embodiment, sensor control module or logic 803 is configured to control certain operations of sensors 810, such as, for example, timing of activation of capturing sensor data, in response to commands received from host system (e.g., perception module 702) via host interface 805. Host system 510 can configure sensors 810 to capture sensor data in a collaborative and/or synchronized manner, such that the sensor data can be utilized to perceive a driving environment surrounding the vehicle at any point in time.

Sensor interface 804 can include one or more of Ethernet, USB (universal serial bus), LTE (long term evolution) or cellular, WiFi, GPS, camera, CAN, serial (e.g., universal asynchronous receiver transmitter or UART), SIM (subscriber identification module) card, and other general purpose input/output (GPIO) interfaces. Host interface 805 may be any high speed or high bandwidth interface such as PCIe (peripheral component interconnect or PCI express) interface. Sensors 810 can include a variety of sensors that are utilized in an autonomous driving vehicle, such as, for example, a camera, a LIDAR device, a RADAR device, a GPS receiver, an IMU, an ultrasonic sensor, a GNSS (global navigation satellite system) receiver, an LTE or cellular SIM card, vehicle sensors (e.g., throttle, brake, steering sensors), and system sensors (e.g., temperature, humidity, pressure sensors), etc.

For example, a camera can be coupled via an Ethernet or a GPIO interface. A GPS sensor can be coupled via a USB or a specific GPS interface. Vehicle sensors can be coupled via a CAN interface. A RADAR sensor or an ultrasonic sensor can be coupled via a GPIO interface. A LIDAR device can be coupled via an Ethernet interface. An external SIM module can be coupled via an LTE interface. Similarly, an internal SIM module can be inserted onto a SIM socket of sensor unit 800. The serial interface such as UART can be coupled with a console system for debug purposes.

Note that sensors 810 can be any kind of sensors and provided by various vendors or suppliers. Sensor processing module 801 is configured to handle different types of sensors and their respective data formats and communication protocols. According to one embodiment, each of sensors 810 is associated with a specific channel for processing sensor data and transferring the processed sensor data between host system 510 and the corresponding sensor. Each channel includes a specific sensor processing module and a specific data transfer module that have been configured or programmed to handle the corresponding sensor data and protocol, as shown in FIG. 8B.

Referring now to FIG. 8B, sensor processing modules 801A-801C are specifically configured to process sensor data obtained from sensors 810A-810C respectively. Note that sensors 810A-810C may the same or different types of sensors. Sensor processing modules 801A-801C can be configured (e.g., software configurable) to handle different sensor processes for different types of sensors. For example, if sensor 810A is a camera, processing module 801A can be figured to handle pixel processing operations on the specific pixel data representing an image captured by camera 810A. Similarly, if sensor 810A is a LIDAR device, processing module 801A is configured to process LIDAR data specifically. That is, according to one embodiment, dependent upon the specific type of a particular sensor, its corresponding processing module can be configured to process the corresponding sensor data using a specific process or method corresponding to the type of sensor data.

Similarly, data transfer modules 802A-802C can be configured to operate in different modes, as different kinds of sensor data may be in different size or sensitivities that require different speed or timing requirement. According to one embodiment, each of data transfer modules 802A-802C can be configured to operate in one of a low latency mode, a high bandwidth mode, and a memory mode (also referred to as a fixed memory mode).

When operating in a low latency mode, according to one embodiment, a data transfer module (e.g., data transfer module 802) is configured to send the sensor data received from a sensor to the host system as soon as possible without or with minimum delay. Some of sensor data are very sensitive in terms of timing that need to be processed as soon as possible. Examples of such sensor data include vehicle status such as vehicle speed, acceleration, steering angle, etc.

When operating in a high bandwidth mode, according to one embodiment, a data transfer module (e.g., data transfer module 802) is configured to accumulate the sensor data received from a sensor up to a predetermined amount, but is still within the bandwidth the connection between the data transfer module and the host system 510. The accumulated sensor data is then transferred to the host system 510 in a batch that maximum the bandwidth of the connection between the data transfer module and host system 510. Typically, the high bandwidth mode is utilized for a sensor that produces a large amount of sensor data. Examples of such sensor data include camera pixel data.

When operating in a memory mode, according to one embodiment, a data transfer module is configured to write the sensor data received from a sensor directly to a memory location of a mapped memory of host system 510, similar to a shared memory page. Examples of the sensor data to be transferred using memory mode include system status data such as temperature, fans speed, etc.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A method of processing camera image data in an autonomous driving (ADV), the ADV including a main compute unit coupled to a field programmable gate array (FPGA) unit and a graphical processing unit (GPU), the method comprising:
receiving, by the main compute unit, a full raw image data and a partial compressed image data from the FPGA unit, wherein the full raw image is raw image data captured by a plurality of cameras mounted on the ADV, wherein the partial compressed image data is compressed from a partial raw image data captured by a subset of the plurality of cameras;
transmitting, by the main compute unit, the partial compressed image data to a remote driving operation center; and
consuming, by the main compute unit, the full raw image data for environment perception, wherein the full raw image data is also compressed into a full compressed image data by the GPU.

2. The method of claim 1, further comprising:
transmitting, by the main compute unit, the full compressed image data to a cloud server for storage.

3. The method of claim 1, wherein the GPU compressing the full raw image data into the full compressed image data further comprises:
calling, by the main compute unit, a software application program interface (API) of the GPU to compress the full raw image data; or
sending, by the main compute unit, the full raw image data to the GPU for compression.

4. The method of claim 1, wherein the FPGA unit includes a logic block for specifying the subset of the plurality of cameras.

5. The method of claim 1, wherein the main compute unit receives the full raw image data from a buffer on the FPGA unit.

6. The method of claim 1, wherein the FPGA unit includes an image data compression block which is programmed to compress the partial raw image data into the partial compressed image data.

7. The method of claim 1, wherein the main compute unit is coupled to the FPGA unit via an Ethernet interface and a first peripheral component interconnect express (PCIe) interface.

8. The method of claim 7, wherein the Ethernet interface is used to transmit the partial compressed image data from the FPGA unit to the main compute unit, and wherein the first PCIe interface is used to transmit the full raw image data from the FPGA unit to the main compute unit.

9. The method of claim 8, wherein the partial compressed image data is transmitted from the FPGA unit to the main compute unit as user datagram protocol (UDP) packets.

10. The method of claim 1, wherein the main compute unit includes a camera sensor driver that is configured to retrieve the full raw image data via a second PCIe interface, and put the retrieved full raw image data to a memory of the main compute unit.

11. A data processing system for processing camera image data in an autonomous driving vehicle (ADV), comprising:
a main compute unit;
a graphics processing unit (GPU) coupled to the main compute unit;
a field programmable gate array (FPGA) unit coupled to the main compute unit;
wherein the main compute unit execute program instructions to perform instructions to perform operations comprising:
receiving a full raw image data and a partial compressed image data from the FPGA unit, wherein the full raw image is raw image data captured by a plurality of cameras mounted on the ADV, wherein the partial compressed image data is compressed from a partial raw image data captured by a subset of the plurality of cameras;
transmitting the partial compressed image data to a remote driving operation center; and
consuming the full raw image data for environment perception, wherein the full raw image data is also compressed into a full compressed image data by the GPU.

12. The data processing system of claim 11, wherein the operations further comprise:
transmitting the full compressed image to a cloud server for storage.

13. The data processing system of claim 11, wherein the GPU compressing the full raw image data into the full compressed image data further comprises:
calling a software application program interface (API) of the GPU to compress the full raw image data; or
sending the full raw image data to the GPU for compression.

14. The data processing system of claim 11, wherein the FPGA unit includes a logic block for specifying the subset of the plurality of cameras.

15. The data processing system of claim 11, wherein the main compute unit receives the full raw image data from a buffer on the FPGA unit.

16. The data processing system of claim 11, wherein the FPGA unit includes an image data compression block which is programmed to compress the partial raw image data into the partial compressed image data.

17. The data processing system of claim 11, wherein the main compute unit is coupled to the FPGA unit via an Ethernet interface and a first peripheral component interconnect express (PCIe) interface.

18. The data processing system of claim 17, wherein the Ethernet interface is used to transmit the partial compressed image data from the FPGA unit to the main compute unit, and wherein the first PCIe interface is used to transmit the full raw image data from the FPGA unit to the main compute unit.

19. The data processing system of claim 18, wherein the partial compressed image data is transmitted from the FPGA unit to the main compute unit as user datagram protocol (UDP) packets.

20. A non-transitory computer-readable medium storing instructions, which, executed by a main compute unit of an autonomous driving vehicle (ADV), cause the main compute unit to perform operations comprising:
receiving a full raw image data and a partial compressed image data from the FPGA unit, wherein the full raw image is raw image data captured by a plurality of cameras mounted on the ADV, wherein the partial compressed image data is compressed from a partial raw image data captured by a subset of the plurality of cameras;
transmitting the partial compressed image data to a remote driving operation center; and
consuming the full raw image data for environment perception, wherein the full raw image data is also compressed into a full compressed image data by the GPU.
